(19) United States
(12) Patent Application Publication
(10) Pub. No.: US 2004/0238981 A1
(43) Pub. Date: Dec. 2, 2004

(54) Preparation of quartz-free dental investment and application

(75) Inventor: Joachim Weiss, Bremen (DE)

Correspondence Address: Michael B. Lasky, Altera Law Group, 6500 City West Parkway - Suite 100, Minneapolis, MN, 55344-7704, US

(73) Assignee: BEGO Bremer Goldschlagerei Wilh, Herbst GmbH & Co., Bremen (DE)

(21) Appl. No.: 10/878,771

(22) Filed: Jun. 28, 2004

Related U.S. Application Data
(63) Continuation of application No. 10/447,767, filed on May 29, 2003, now abandoned.

(30) Foreign Application Priority Data
May 29, 2002 (DE) 102 23 883.9-23

(51) Int. Cl. A61C 13/00

(52) U.S. Cl. 264/16

(57) ABSTRACT

The present invention relates to a method for the fabrication of a dental cast part having the following steps: Forming and hardening a first working model of a dentition, in such a way that the material used for fabrication of the working model expands during hardening; modelling a restoration from a modelling material on the first working model or a second working model that is essentially identical to the first working model in respect of its dimensions; embedding the restoration model in a settable dental investment that is at least essentially quartz-free; hardening the dental investment; removing the restoration model from the dental investment so that a casting form is created; introducing liquid metal into the casting form and allowing the metal to solidify in the casting form; removal of the metal that has solidified to form a dental cast part.

The present invention relates to a method for the fabrication of dental cast parts.

For the fabrication of dental cast parts such as, for example, crowns and bridges or model cast dentures, a refractory dental investment is required which has expansion values that compensate for the particular contraction of the alloy used so as to be able to seat an accurately fitting dental prosthesis in the mouth of the patient. When fabricating crowns and bridges an impression of the prepared tooth stumps is normally made by a dentist. A settable material is then cast in the resulting impression, usually in a dental laboratory, to produce a first working model. The dental technician models a restoration (casting) from a modelling material (for example wax or a low-melting plastic) on the resulting (first) working model. The restoration model is then lifted from the (first) positive likeness and embedded in a dental investment. After the dental investment has hardened (set), the modelling material is burnt out, so that a form for casting the dental cast part is now created, which normally is intended as replacement for a missing part of a tooth or dentition.

When making model cast dentures (model casting technique) an impression of the prepared residual dentition is likewise taken by a dentist. In a dental laboratory a settable material is cast in this impression to produce a first working model. A negative likeness is produced from this first working model using a duplicating material (for example hydrogel, silicone or polyether), a dental investment is cast in this negative likeness and a new, somewhat enlarged working model (second working model) is thus produced. The dental technician models the planned dental prosthesis on this second working model in wax or plastic. This working model is then boxed with refractory dental investment in a prespecified form. By burning out the modelling material in a preheating furnace, a casting mould is produced into which the liquefied metal is centrifuged or filled under pressure.

To date, formulations based on plaster are usually used as materials for fabrication of the (first) positive likeness, in which context according to DE 196 41 348 C1 a setting expansion of only in the range between approximately 0.2 and 0.06% (V/V) occurs, depending on the precise composition of the material essentially consisting of plaster.

Compositions which contain a high proportion of quartz or modifications thereof (tridymite; cristobalite) as base material are normally used as dental investment; in addition to the base material, the dental investment normally contains binders as well as, optionally, additives for adjusting the expansion characteristics and further characteristics of the dental investment. According to DE 196 41 348 C1 commercially available dental investments have an expansion of between approximately 0.5 and 3.5% (V/V), it being possible for this expansion to be controlled by the concentration of the mixing liquid used. To adjust the concentration, distilled water is added to the mixing liquid or the amount of mixing liquid is varied. In particular cases the expansion can also be controlled by completion of defined temperature programmes.

In order to achieve an optimum accurate fit of the dental metal (dental alloy) that has solidified in the casting form with contraction, producers have to date attempted to control the expansion characteristics of the investment material by varying its chemical composition.

However, when quartz and its modifications cristobalite or tridymite are used there is the risk, especially in the case of unprotected exposure in a dental laboratory over many years, of contracting silicosis or even lung cancer. The aim of the present invention was, therefore, to indicate a method for the fabrication of a dental cast part with which a dental investment that is at least substantially quartz-free is used. Within the context of the present text, the term “quartz-free” signifies “free from quartz and the modifications cristobalite, tridymite and quartz glass thereof”. In this context the method to be indicated is intended to make available dental cast parts which in respect of their accuracy of fit correspond to the cast parts fabricated in the conventional manner or at least can still be used for further processing to give an accurately fitting product.

According to the invention the stated aim is achieved by a method for the fabrication of a dental cast part having the following steps:

a.) Forming and hardening a first working model of a dentition, in such a way that the material used for fabrication of the working model expands during hardening,

b.) Modelling a restoration from a modelling material on the first working model or a second working model that is essentially identical to the first working model in respect of its dimensions,

c.) Embedding the restoration model in a settable dental investment that is at least essentially quartz-free,

d.) Hardening the dental investment

e.) Removing the restoration model from the dental investment so that a casting form is created,

f.) Introducing liquid metal into the casting form and allowing the metal to solidify in the casting form.

g.) Removal of the metal that has solidified to form a dental cast part.

In practice a person skilled in the art differentiates between certain fabrication methods for dental cast parts and usually refers to these methods as “crown and bridge technique”, “model casting technique”, “model casting lifting technique”, etc.

Preferred embodiments for the three specifically mentioned methods are indicated below.

Crown and bridge technique:

Forming and hardening a (first) working model of a dentition, in such a way that the material used to fabricate the working model expands during hardening (for example, high-expanding plaster can be used as material). Note: In this context it is normally either possible (sic) to control the expansion characteristics of the modelling material using a mixing liquid or using a non-liquid expansion agent. Alternatively, modelling materials which each have different expansion stages adapted to the intended application are offered, so that further control of the expansion characteristics can be dispensed with.

Modelling of a restoration (model of the cast part to be fabricated) from a (meltable) modelling material (for example wax or a low-melting plastic) on the (hardened first) working model (that is enlarged compared with the original dentition),

Embedding the restoration model (for example wax or plastic model) (previously removed from the positive likeness) in an at least essentially quartz-free, settable dental investment (in this context a content of 1% (m/m) quartz or modification thereof is still regarded as essentially quartz-free),

Hardening (setting) the dental investment,

Removal of the restoration model from the dental investment so that a casting form is created (as a rule the restoration model is removed from the casting form) by burning out,

Introducing (usually pouring in) liquid metal into the casting form and allowing the metal to solidify in the casting form.

Model casting technique:

Forming and hardening a (first) working model of a dentition in such a way that the material used to fabricate the working model expands during hardening (for example high-expanding plaster can be used as material). Note: the note in respect of the “crown and bridge technique” applies here correspondingly.

Duplicating the oversized model with the aid of suitable duplicating materials (for example hydrogel, silicone or polyether); production of a (second) working model,

Modelling a restoration (model of the cast part to be fabricated) from a (meltable) modelling material (for example wax or a low-melting plastic) on the (hardened second) working model (that is enlarged compared with the original dentition) made of an at least essentially quartz-free, settable dental investment (in this context a content of 1% (m/m) quartz or modification thereof is still regarded as essentially quartz-free).

Embedding the restoration model (for example wax or plastic model) and the dental investment model (second positive likeness) carrying this in an at least essentially quartz-free, settable dental investment (in this context a content of 1% (m/m) quartz or its modification is still regarded as essentially quartz-free),

Hardening (setting) the dental investment,

Removal of the restoration model from the dental investment so that a casting form is created (as a rule the restoration model is removed from the casting form by burning out),

Introducing (usually pouring in) liquid metal into the casting form and allowing the metal to solidify in the casting form.

The method according to the invention is preferably so designed that the solidified metal is further processed to give a restoration that can be seated.

Alternatively, in some cases the method of the model casting lifting technique (in particular with an easily setting modelling material) is to be preferred. In this case the restoration is undertaken by means of a settable material (for example wax, plastic) on the first positive likeness made of modelling material. The restoration is then lifted from the model and embedded analogously to the procedure in the crown and bridge technique. After hardening (setting) of the dental investment, the modelling material is burnt out so that a casting form for casting the dental cast part, which normally is intended as replacement for a missing part of a tooth or dentition, is now created.

With this method conventional dental alloys can, in particular, be used as liquid metal.

In this context the invention is based on the finding that the fabrication of technical cast parts which already have acceptable accuracy of fit is also possible using at least essentially quartz-free dental investment if the material used to fabricate the (first) positive likeness expands sufficiently during hardening (setting).

For optimum design of the process, the material combination of modelling material and dental investment is preferably so matched to one another that the contraction of the alloy during cooling thereof is precisely compensated for by the expansion of the two materials.

Whereas with the conventional systems for the fabrication of a dental cast part the unavoidable contraction of the metal has been counteracted by a corresponding expansion of the dental investment, which essentially is determined by the particular thermal expansion capacity of the quartz and modifications thereof, a different route is taken by the present invention. Specifically, since the dental investment used is essentially quartz-free, it normally has a lower expansion capacity than dental investments customary on the market. According to the invention some of the contraction of the metal is therefore matched by the use of a material for the fabrication of the (first) positive likeness which expands to a considerable extent during hardening (setting). Here the degree of expansion of the said material is normally greater than the degree of expansion in the case of the materials customary hitherto for working models (such as, for example, materials based on plaster). It is advantageous if the material employed for the fabrication of the positive likeness is so selected that it expands by at least 0.25% (V/V) during hardening.

The (first) positive likeness initially fabricated in the method according to the invention is thus enlarged compared with the original dental topography. However, because of the volume contraction of the dental metal, the finished cast part is again reduced in size compared with the (first) positive likeness and the person skilled in the art is able, on the basis of simple experiments, to select a material pairing from

(1) the material for the fabrication of the (first) positive likeness and

(2) the dental metal

with which the volume expansion of the positive likeness material, on the one hand, and the volume contraction of the liquid dental metal, on the other hand, at least essentially compensate for one another.

With this method the dental investment can certainly still have its own expansion capacity (for example be subject to expansion on setting), which then, however, must be taken into account when selecting materials and/or when controlling the expansion characteristics.

Dental investments which are particularly suitable for use in the method according to the invention comprise, in addition to refractory ceramic materials (such as, for example, oxides, silicates, etc.), a suitable binder system (such as, for example, aluminium hydrogen phosphate/magnesium oxide or magnesium acetate or the like). On the basis of simple experiments the person skilled in the art will select suitable quartz-free dental investments which possess several of the following properties:

good plastic processibility and controlled solidification to give a solid moulding;

high thermal stability at the casting temperature (depending on the casting metal selected) and when soldering or sintering;

a short processing time suited to the intended application: a few seconds in the case of soldering dental investments up to a few minutes in the case of casting dental investments;

easy removability of the solidified casting;

high temperature corrosion resistance to the dental metal (dental alloy) melt;

high strength, in order to withstand the pressure when casting;

precise impression accuracy for fine details;

adjustable (controllable) expansion characteristics;

adequate pole porosity to allow air and gases to escape;

resistance to changes in temperature;

storage stability

To reduce the delay when filling with the liquid metal, the investment material can contain strengthening inclusions, such as are described in DE 198 08 027 A1.

Preferred embodiments of the method according to the invention can be taken from the dependent claims and the following examples.

### EXAMPLE 1

### Quartz-Free Dental Investment

A (quartz-free) dental investment of the following composition was prepared:

| | Content in dental investment in |
|---|---|
| Substance | % (m/m) |
| Aluminium oxide | 25 |
| Dimagnesium phosphate | 3.4 |
| Magnesium oxide | 7.5 |
| Ammonium dihydrogen phosphate | 9 |
| Wetting agent | 0.1 |
| Nepheline syenite | 40 |
| Zirconium silicate | 15 |

### EXAMPLE 2

### Alternative (Quartz-Free) Dental Investment

A further (quartz-free) dental investment of the following composition was prepared:

| | Content in dental investment in |
|---|---|
| Substance | % (m/m) |
| Dimagnesium phosphate | 3.4 |
| Magnesium oxide | 7.5 |
| Ammonium dihydrogen phosphate | 9 |
| Wetting agent | 0.1 |
| Nepheline syenite | 65 |
| Zirconium silicate | 15 |

### Notes on Examples 1 and 2

The mixing liquid used for the (quartz-free) dental investment according to Examples 1 and 2 can be, for example, silica sol or another sol (such as, for example, zirconium sol).

The alternative compositions in Examples 1 and 2 can contain magnesium in (far) higher concentration.

(Quartz-free) dental investments to be used according to the invention can also contain other inorganic oxides in addition to the oxides mentioned.

As an alternative to the compositions according to Examples 1 and 2, formulations containing the following main constituents can also be used: magnesium oxide, yttrium oxide, cerium oxide and aluminium oxide.

These main constituents are the basis for so-called titanium casting dental investments; the dental investments of this type that can be used in the method according to the invention can be used with dissolved magnesium acetate (optionally with additives) as mixing liquid.

1 A method for the fabrication of a dental cast part having the following steps:
a) forming and hardening a first working model of a dentition using material selected to achieve a predetermined expansion, so that the material used for fabrication of the working model achieves a known expansion during hardening;
b) modeling a restoration from a modeling material on a subsequent working model that is essentially identical to the first working model in respect of its dimensions;
c) embedding the restoration model in a settable dental investment that is at least essentially quartz-free;
d) hardening the dental investment, wherein the dental investment expands during hardening;
e) removing the restoration model from the dental investment so that a casting form is created;
f) introducing liquid metal into the casting form and allowing the metal to solidify in the casting form, wherein the metal contracts during solidification; and
g) removing the metal that has solidified to form a dental cast part, wherein
the expansion of the working model is used to compensate for the contraction of the metal.

2 The method as claimed in claim 1, wherein the solidified metal is further processed to produce a restoration that can be seated.

3 The method as claimed in claim 1, wherein, before carrying out the modeling step, the first working model fabricated according to the forming step is duplicated to give a second working model, wherein the material used to fabricate the second working model is an at least essentially quartz-free settable composition,
and wherein the modeling according to the modeling step is carried out on the second working model.

4-5. (cancelled).

6 The method of claims 1, further comprising using the dental investment material to further compensate for the contraction of the metal.

7 A method for the fabrication of a dental cast part having the following steps:
a) forming and hardening a first working model of a dentition using material selected to achieve a predetermined expansion, so that the material used for fabrication of the working model achieves a known expansion during hardening;
b) modeling a restoration from a modeling material on a second working model that is essentially identical to the first working model in respect of its dimensions;
c) embedding the restoration model in a settable dental investment that is at least essentially quartz-free;
d) hardening the dental investment, wherein the dental investment expands during hardening;
e) removing the restoration model from the dental investment so that a casting form is created;
f) introducing liquid metal into the casting form and allowing the metal to solidify in the casting form, wherein the metal contracts during solidification; and
g) removing the metal that has solidified to form a dental cast part, wherein
the expansion of the working model is used to compensate for the contraction of the metal.

8 The method as claimed in claim 7, wherein the solidified metal is further processed to produce a restoration that can be seated.

9 The method as claimed in claim 7, wherein the material used to fabricate the second working model is an at least essentially quartz-free settable composition.

10 The method of claim 7, further comprising using the dental investment material to further compensate for the contraction of the metal.

11 A method for the fabrication of a dental cast part having the following steps:
a) forming and hardening a first working model of a dentition using material selected to achieve a predetermined expansion, so that the material used for fabrication of the working model achieves a known expansion during hardening;
b) modeling a restoration from a modeling material on the first working model;
c) embedding the restoration model in a settable dental investment that is at least essentially quartz-free;
d) hardening the dental investment, wherein the dental investment expands during hardening;
e) removing the restoration model from the dental investment so that a casting form is created;
f) introducing liquid metal into the casting form and allowing the metal to solidify in the casting form, wherein the metal contracts during solidification; and
g) removing the metal that has solidified to form a dental cast part, wherein
the expansion of the working model is used to compensate for the contraction of the metal.

12 The method as claimed in claim 11, wherein the solidified metal is further processed to produce a restoration that can be seated.

13 The method as claimed in claim 11, wherein, before carrying out the modeling step, the first working model fabricated according to the forming step is duplicated to give a second working model, wherein the material used to fabricate the second working model is an at least essentially quartz-free settable composition.

14 The method of claim 11, further comprising using the dental investment material to further compensate for the contraction of the metal.
